(19) United States
(12) Patent Application Publication
(10) Pub. No.: US 2026/0209095 A1
(43) Pub. Date: Jul. 23, 2026

(54) METHOD AND DEVICE FOR PURIFYING WATER

(71) Applicant: WATER IQ INTERNATIONAL B.V., Eindhoven (NL)

(72) Inventor: Freddy DEKKERS, Eindhoven (NL)

(21) Appl. No.: 19/142,213

(22) PCT Filed: Dec. 15, 2023
(86) PCT No.: PCT/NL2023/050663

§ 371 Date: Jun. 22, 2025

(30) Foreign Application Priority Data
Dec. 21, 2022 (NL) 2033788

(51) Int. Cl. C02F 9/00; C02F 1/28; C02F 1/461; C02F 1/467

(52) U.S. Cl. CPC C02F 9/00; C02F 1/281; C02F 1/46109; C02F 2001/46147; C02F 1/4676

(57) ABSTRACT

In a method for purifying water, the contaminated water is passed from top to bottom through an adsorption column 3 filled with adsorption material. The adsorption column is filled with chemically charged ceramic granules in which contamination present in the water is bound to the adsorption material. The pretreated water then flows through an initiation mixing chamber 5 into which hydrogen peroxide is injected and then electrolysis of hydrogen peroxide takes place, forming hydrogen radicals, after which a liquid catalyst is injected. The pretreated water is then passed from bottom to top through a reduction column 11. This reduction column is filled with a ceramic carrier on which a catalyst has been applied. In the reduction column, chemical compounds are reduced to elementary substances by the hydrogen radicals under the influence of the liquid catalyst. The reduction steps with initiation steps are repeated a number of times in further initiation mixing chambers 5 and further reduction columns 11 in order to achieve a staged degradation.

### TECHNICAL FIELD OF THE INVENTION

The invention relates to a method for purifying water. More specifically, the invention relates to a method for purifying water contaminated with poly-and perfluoroalkyl substances, aromatics, pharmaceutical residues and other contaminants that are difficult to degrade.

### BACKGROUND OF THE INVENTION

Methods for purifying water are well known. Activated carbon granules are used to purify water contaminated with contamination that is difficult to break down. This removes the pollution from the water through adsorption.

US 2021/079997 A1 discloses a method for purifying water in which a liquid catalyst and hydrogen peroxide are injected into an oxidation tower filled with a catalyst mounted on a ceramic carrier and the treated water is recirculated by means of a circulation pump.

### SUMMARY OF THE INVENTION

It is an object of the present invention to provide a method for purifying water that provides better purification than known methods. To this end, the method for purifying water according to the invention is characterized in that the method comprises the following steps:
passing the water to be treated from top to bottom through an adsorption column filled with adsorption material formed by ceramic granules provided with a chemically bonded cation coating with a cationic charge in which anionically charged colloidally dispersed particles present in the water are bound to the adsorption material,
allowing the pretreated water to flow through an initiation mixing chamber into which hydrogen peroxide and a liquid catalyst are injected, which brings about a catalysis of the added hydrogen peroxide, said catalyst comprising manganese dioxide and/or a palladium, iron and/or copper ion complex and in which chamber initiation of a reduction reaction takes place by electrolysis, in which hydrogen radicals are formed by a catalysis reaction of the added hydrogen peroxide to the anode,
passing the pretreated water from bottom to top through a reduction column filled with active carrier material formed by a ceramic carrier on which a catalyst has been applied which effects a catalysis of the added hydrogen peroxide, comprising aluminum, palladium, iron and/or copper ions, for the formation of hydrogen radicals from hydrogen peroxide, after which the hydrogen radicals reduce the chemical compounds to elementary substances, and
repeating the second and third steps a number of times in further initiation mixing chambers and further reduction columns.

The cationic charge can, for example, be obtained from potassium, lithium, sodium, calcium and/or magnesium ions.

The electrolysis cells initiate the reduction reaction preferably under a voltage of 6-24VDC, in which hydrogen radicals are formed. The anode and cathode of the electrolytic cells are preferably made of diamond, PbO₂ or an equivalent material.

With this method, water contaminated with poly- and perfluoroalkyl substances, aromatics, medicine residues and other difficult-to-degrade contamination can be cleaned effectively and efficiently.

Preferably, the water is evenly distributed over the cross-section of the adsorption column before the water is introduced into the adsorption column. Furthermore, the water is preferably evenly distributed over the cross-section of the reduction column before it is fed into the reduction column.

The invention also relates to a device for purifying water. As far as the device is concerned, the invention is characterized in that the device comprises:
an adsorption column filled with adsorption material formed by ceramic grains with a cationic charge, as well as
a number of reduction columns in series filled with active carrier material formed by a ceramic carrier on which a catalyst comprising aluminum, palladium, iron and/or copper ions has been applied, and
a number of initiation mixing chambers, with an initiation mixing chamber for each reduction column, which initiation mixing chambers are each provided with a first injector for injection of hydrogen peroxide and a second injector for a liquid catalyst and a number of electrolysis cells whose anode and cathode are made of diamond, PbO2 or an equivalent material.

With this device, water contaminated with contamination that is difficult to break down can be cleaned effectively and efficiently.

An embodiment of the device for purifying water is characterized in that at the top of the adsorption column there is a distribution plate provided with fine holes evenly distributed over the surface of the column.

A further embodiment of the device for purifying water is characterized in that the adsorption column is provided with a backwashing device to rinse away the bound contamination.

Yet another embodiment of the device for purifying water is characterized in that the reduction column is provided at the bottom with a distribution chamber for evenly distributing the water so that optimal contact of the water with the carrier material is achieved in the reduction column.

The anode/cathode of the electrolysis cells are preferably made of diamond, PbO₂ or an equivalent material.

The catalyst solution preferably contains a complex of metal ions, including copper, iron, cobalt and palladium ions.

### BRIEF DESCRIPTION OF THE DRAWINGS

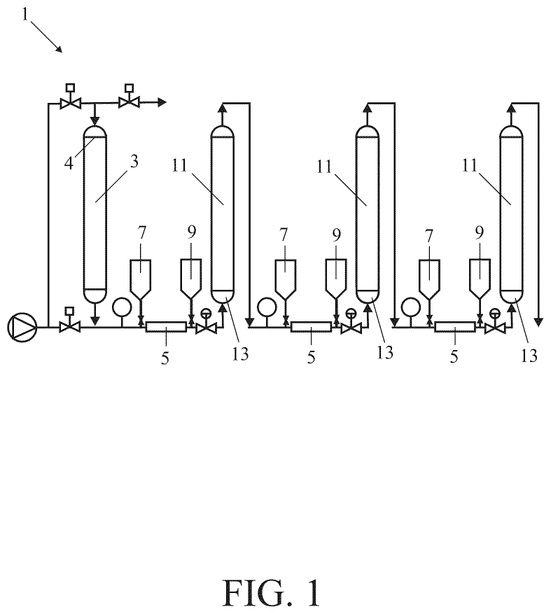

The invention will be further elucidated below on the basis of drawings. These drawings show an embodiment of the method and device according to the present invention. In the drawings is FIG. 1 a schematic representation of the device according to the invention.

### DETAILED DESCRIPTION OF THE DRAWINGS

FIG. 1 shows schematically an embodiment of the device for purifying contaminated water according to the invention. The device 1 has an adsorption column 3 filled with adsorption material and a number of reduction columns 11 in series filled with active carrier material. For each reduction column 11 there is an initiation mixing chamber 5 in which a number of electrolysis cells are located as well as two injectors, a first injector 7 for injection of hydrogen peroxide and a second injector 9 for injection of a liquid catalyst. The active support material in the reduction columns 11 is formed by a ceramic support on which a catalyst has been applied that effects catalysis of the added hydrogen peroxide. The adsorption material in the adsorption column 3 is formed by ceramic granules with a cationic charge formed by potassium, lithium, sodium, calcium and/or magnesium ions. The active support material in the reduction columns is formed by a ceramic support on which a catalyst comprising aluminum, palladium, iron and/or copper ions has been applied.

The untreated water is purified in a number of steps in an adsorption column 3 and several reduction columns 11. In the adsorption column 3 the water is fed from top to bottom. The untreated water is evenly distributed over the surface of the adsorption column 3 by means of a distribution plate 4 provided with fine holes at the top of the adsorption column to ensure an even distribution of the water. The ceramic granules in the adsorption column are provided with a chemically bonded cation coating with a cationic charge. Anionically charged colloidally dispersed particles present in the water are bound to the adsorption material by adsorption. The adsorption column 3 is equipped with a backwashing device to rinse away the bound contamination.

The initiation mixing chamber 5 is provided with electrolysis cells and injection points for the injection of hydrogen peroxide and a liquid catalyst solution comprising manganese dioxide and/or a palladium, iron and/or copper ion complex. The catalyst solution contains a complex of metal ions, including copper, iron, cobalt and palladium ions. The electrolysis cells initiate the reduction reaction at the anode under a voltage of 6-24V DC, whereby hydrogen radicals are formed in the reduction column connected after the mixing chamber. The anode/cathode of the electrolysis cells are made of diamond, PbO₂ or an equivalent material.

After the initiation mixing chamber 5, the pretreated water is passed from bottom to top through the reduction column 11 in which chemical compounds are reduced to elementary substances by the hydrogen radicals under the influence of the liquid catalyst. Before the water is fed into the reduction column 11, the water is first fed to a distribution chamber 13 at the bottom of the reduction column, in which the water is evenly distributed to ensure optimal contact of the water with the carrier material in the reduction column.

The active carrier material in the reduction column 11 is provided with a catalyst arranged on a ceramic carrier. This catalyst also contains a complex of metal ions, including copper, iron, cobalt and palladium ions. When the water comes into contact with the catalyst, hydrogen radicals are formed from hydrogen peroxide. These hydrogen radicals reduce chemical compounds including aromatics and PFAS to elementary substances. The reduction steps with initiation steps are repeated a number of times to achieve a gradual degradation.

Although the present invention is elucidated above on the basis of the given drawings, it should be noted that this invention is not limited whatsoever to the embodiments shown in the drawings. The invention also extends to all embodiments deviating from the embodiments shown in the drawings within the scope of the invention defined by the appended claims.

1. Method for purifying water comprising:
passing the water to be treated from top to bottom through an adsorption column (3) filled with adsorption material formed by ceramic granules provided with a chemically bonded cation coating with cationic charge in which anionically charged colloidally dispersed particles present in the water are bound to the adsorption material,
passing the pretreated water through an initiation mixing chamber (5) into which hydrogen peroxide and a liquid catalyst are injected, which effects a catalysis of the added hydrogen peroxide, said catalyst comprising manganese dioxide and/or a palladium, iron and/or copper ion complex and in which chamber by electrolysis initiation of a reduction reaction takes place, in which hydrogen radicals are formed by a catalysis reaction of the added hydrogen peroxide to the anode, passing the pretreated water from bottom to top through a reduction column (11) filled with active carrier material formed by a ceramic carrier on which a catalyst has been applied which effects a catalysis of the added hydrogen peroxide, comprising aluminum, palladium, iron and/or copper ions, for the formation of hydrogen radicals from hydrogen peroxide, after which the hydrogen radicals reduce the chemical compounds to elementary substances, and
repeating the second and third steps a number of times in further initiation mixing chambers (5) and further reduction columns (11).

2. Method according to claim 1, characterized in that before the water is introduced into the adsorption column (3), the water is evenly distributed over the crosssection of the adsorption column.

3. Method according to claim 1, characterized in that before the water is fed into the reduction column (11), the water is evenly distributed over the cross-section of the reduction column.

4. Device (1) for purifying water, comprising:
an adsorption column (3) filled with adsorption material formed by ceramic grains with a cationic charge, as well as
a number of reduction columns (11) in series filled with active carrier material formed by a ceramic carrier on which a catalyst comprising aluminum, palladium, iron and/or copper ions has been applied, and
a number of initiation mixing chambers (5), whereby an initiation mixing chamber is present for each reduction column, which initiation mixing chambers are each provided with a first injector (7) for injection of hydrogen peroxide and a second injector (9) for a liquid catalyst and a number of electrolysis cells of which the anode and cathode of diamond, PbCh or equivalent material.

5. Device for purifying water according to claim 4, characterized in that at the top of the adsorption column (3) there is a distribution plate (4) provided with fine holes evenly distributed over the surface of the column.

6. Device for purifying water according to claim 4, characterized in that the adsorption column (3) is provided with a backwashing device to rinse away the bound contamination.

7. Device for purifying water according to claim 4, characterized in that the reduction column (11) is provided at the bottom with a distribution chamber (13) for evenly distributing the water so that optimal contact of the water with the carrier material in the reduction column is achieved.

8. Device for purifying water according to claim 4, characterized in that the anode/cathode of the electrolysis cells are made of diamond, PbCh or an equivalent material.

9. Device for purifying water according to claim 4, characterized in that the catalyst solution contains a complex of metal ions, including copper, iron, cobalt and palladium ions.
